(19) United States
(12) Patent Application Publication
(10) Pub. No.: US 2002/0040443 A1
(43) Pub. Date: Apr. 4, 2002

(54) Single chip microprocessor with a power save capability

(76) Inventors: Kouichi Maeda, Anjo-shi (JP); Yoshinori Teshima, Toyota-shi (JP); Hiroshi Fujii, Aichi-ken (JP); Hideaki Ishihara, Okazaki-shi (JP)

Correspondence Address: LAW OFFICE OF DAVID G POSZ, 2000 L STREET, N.W., SUITE 200, WASHINGTON, DC, 20036, US

(21) Appl. No.: 09/908,493

(22) Filed: Jul. 19, 2001

(30) Foreign Application Priority Data
Jul. 21, 2000 (JP) 2000-220563

(51) Int. Cl. G06F 1/26; G06F 1/32

(52) U.S. Cl. 713/320

(57) ABSTRACT

A single-chip microprocessor integrated circuit (IC) with a power saving function. The power saving function is achieved by address bus control and/or unique clock circuit. The invention is applicable to a single-chip microprocessor including a CPU; a CPU address bus; and a peripheral circuit comprising a plurality of circuit blocks connected with a peripheral address bus. All or a part of address data provided on the CPU address bus is passed to the peripheral address bus only if the address data is a peripheral address. The passed address is used for address decoding that involves switching. An inventive clock circuit provides each of the circuit blocks with one of predetermined clock signals according to clock control data given by the CPU.

### BACKGROUND OF THE INVENTION

1. Field of the Invention

The invention relates to microprocessors, and more specifically to single-chip microprocessor integrated circuits.

2. Description of the Prior Art

FIG. 1 is a functional block diagram showing an architecture of a prior art single-chip microprocessor IC (integrated circuit). In FIG. 1, microprocessor 1 comprises CPU (central processing unit) 10 as a hub, ROM (read only memory) 11, RAM (random access memory) 12, core data bus 30 and address bus 40 through which CPU 10 communicates with ROM 11 and RAM 12, clock circuit 13, and various peripheral devices such as serial I/O (input and/or output) device 20, PWM (pulse width modulation) circuit 21, timer 22, analog-to-digital converter (A/D) 23, etc.

In order to enable CPU 10 to communicate with such the peripheral devices 20 through 23, the microprocessor 1 further comprises peripheral data bus 32 that interconnects the peripheral devices 20 through 23, data bus interface (IF) 31 that provides an interface between core data bus 30 and peripheral data bus 32, and one or more address decoders 42 and 44. Address decoder 42 decodes the address data launched on the address bus 40 by CPU 10 to provide chip select signals associated with clock circuit 13 (so arranged as to permit CPU 10 to set the output frequency thereof), circuit blocks constituting ROM 11 and RAM 12 and a peripheral circuit 20-23, which we refer to the peripheral devices 20 through 23 en bloc as. The chip select signals include a signal (ADO) that is activated when CPU 10 has an access to any of peripheral devices 20 through 23. On the basis of the address decoder output signal ADO, and the read and write signals RD and WT from CPU 10, the data bus interface 31 permits the flow of data between core 30 and peripheral 32 data buses only when CPU 10 has an access to the peripheral circuit 20-23. Also, data bus interface 31 provides signals PR and PW used for a read operation to read data from any of peripheral devices 20 through 23 and a write operation to write data to any of peripheral devices. Address decoder 44 also decodes the address data from CPU 10 to provide peripheral chip select signals associated with peripheral devices 20 through 23.

The clock circuit 13 generates a clock signal MCK commonly used in the core portion that is comprised of CPU 10, ROM 11 and RAM 12 and the peripheral circuit 20-23 so that the core portion 10-12 and the peripheral circuit 20-23 operate in synchronism with the clock signal MCK. The frequency of the clock signal MCK can be set by CPU 10.

In thus configured conventional signal-chip microprocessor ICs, the address data from CPU 10 is supplied as it is to address decoder 44, which forces address decoder 44 to be always switching even when the access is made to ROM 11 or RAM 12. This causes an increase in the power consumption.

Also, in order to obtain a certain level of performance from the microprocessor IC, the frequency of the clock MCK has to be set the higher. However, since a common clock is used for both the core portion 10-12 and the peripheral circuit 20-23, the peripheral circuit 20-23, which is not required to operate at a high speed, is forced to operate at a speed more than required, also causing an increase in the power consumption. This is especially true when there is any peripheral device(s) that is not used for the application in the processor IC 1 as is sometimes the case with multi-purpose single-chip microprocessor ICs.

The present invention has been made in order to overcome these problems. An object of the invention is to provide a single-chip microprocessor IC the power consumption of which is held down through the separation of the address bus between a core portion including the CPU and each of one or more peripheral portion(s).

Another object of the invention is to provide a single-chip microprocessor IC the power consumption of which is held down by supplying the peripheral devices with respective clock signals of optimized frequencies.

### SUMMARY OF THE INVENTION

According to an aspect of the invention, a single-chip microprocessor integrated circuit (IC) with a power saving function based on address bus control is provided. The single-chip microprocessor IC includes: a CPU (central processing unit); a first address bus directly connected with the CPU; and a peripheral circuit. The peripheral circuit comprises a plurality of circuit blocks that are accessible from the CPU via data bus interface; and a second address bus connected in common with the circuit blocks. The single-chip microprocessor IC further comprises: means for generating chip select signals for the circuit blocks; and means, inserted between the first and second address buses, for passing at least a part of address data provided on the first address bus by the CPU to the second address bus only if the address data is a peripheral address intended for any of the circuit blocks. The means for generating chip select signals operates on the basis of the data provided on the second address bus.

According to another aspect of the invention, a single-chip microprocessor IC with a power saving function achieved by an inventive clock circuit is provided. The single-chip microprocessor ID comprises: a CPU (central processing unit); a peripheral circuit; the peripheral circuit comprising a plurality of circuit blocks that are accessible from the CPU; means for generating a first clock signal used by the CPU; and means for providing each of the circuit blocks with one of predetermined clock signals.

Preferable embodiments have both of the above-mentioned power saving functions.

### BRIEF DESCRIPTION OF THE DRAWING

Further objects and advantages of the present invention will be apparent from the following description of the preferred embodiments of the invention as illustrated in the accompanying drawing, in which:

FIG. 1 is a functional block diagram showing an architecture of a prior art single-chip microprocessor IC (integrated circuit);

FIG. 2 is a functional block diagram showing an architecture of a single-chip microprocessor IC the power consumption of which has been held down in accordance with an illustrative embodiment of the invention;

FIG. 3 is a block diagram showing an exemplary arrangement of a clock circuit 100 of FIG. 2;

FIG. 4 is a flowchart showing an operation of a CPU 10a (of FIGS. 2 and 8) or 10b (of FIG. 6) when CPU 10a or 10b sets the clock circuit 100 to control the way of the clock circuit 100 supplying clock signals to peripheral devices, e.g., 10 through 23;

FIG. 5 is a timing chart showing the wave forms of relevant signals in a peripheral read operation and a peripheral write operation;

FIG. 6 is a functional block diagram showing an arrangement of a first modification of the single-chip microprocessor IC 2 of FIG. 2;

FIG. 7 is a timing chart showing the wave forms of relevant signals in a peripheral read operation and a peripheral write operation of the single-chip microprocessor IC 2a of FIG. 6;

FIG. 8 is a functional block diagram showing an arrangement of a second modification of the single-chip microprocessor IC 2 of FIG. 2; and

FIG. 9 is a functional block diagram showing an arrangement of a third modification of the single-chip microprocessor IC 2 of FIG. 2.

Throughout the drawing, the same elements when shown in more than one figure are designated by the same reference numerals.

### DETAILED DESCRIPTION OF THE PREFERRED EMBODIMENTS

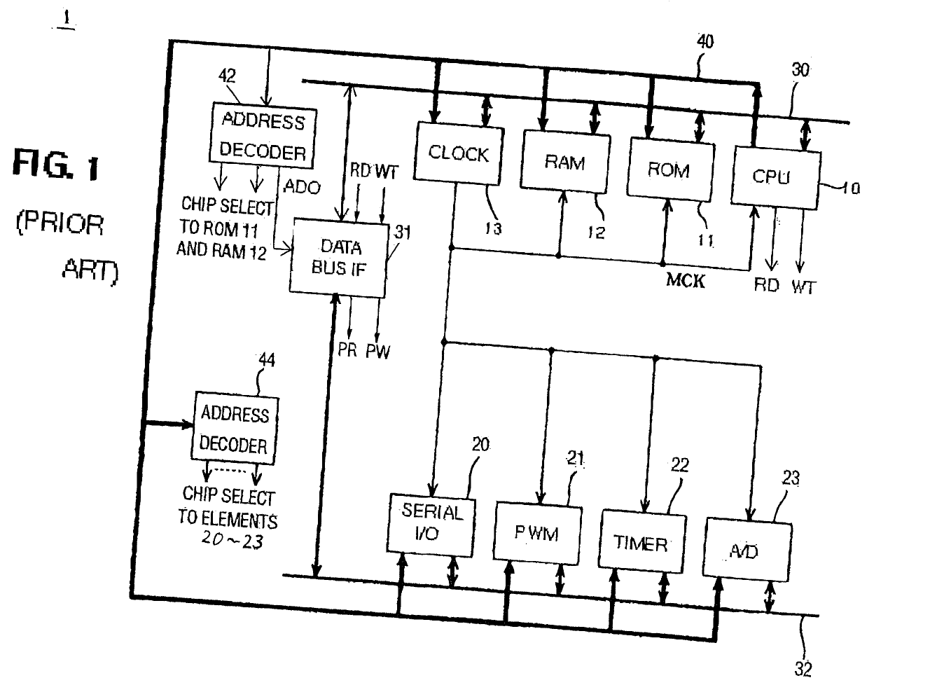

The invention is applicable to any single-chip microprocessor ICs that comprises a core portion including the CPU, the ROM and RAM interconnected with the address and data buses of the CPU and one or more peripheral portion(s) each of which includes one or more peripheral device(s). In order to facilitate the understanding the invention, the invention is detailed by using an example in which the principles of the invention are applied to the single-chip microprocessor IC 1 of FIG. 1 in the following.

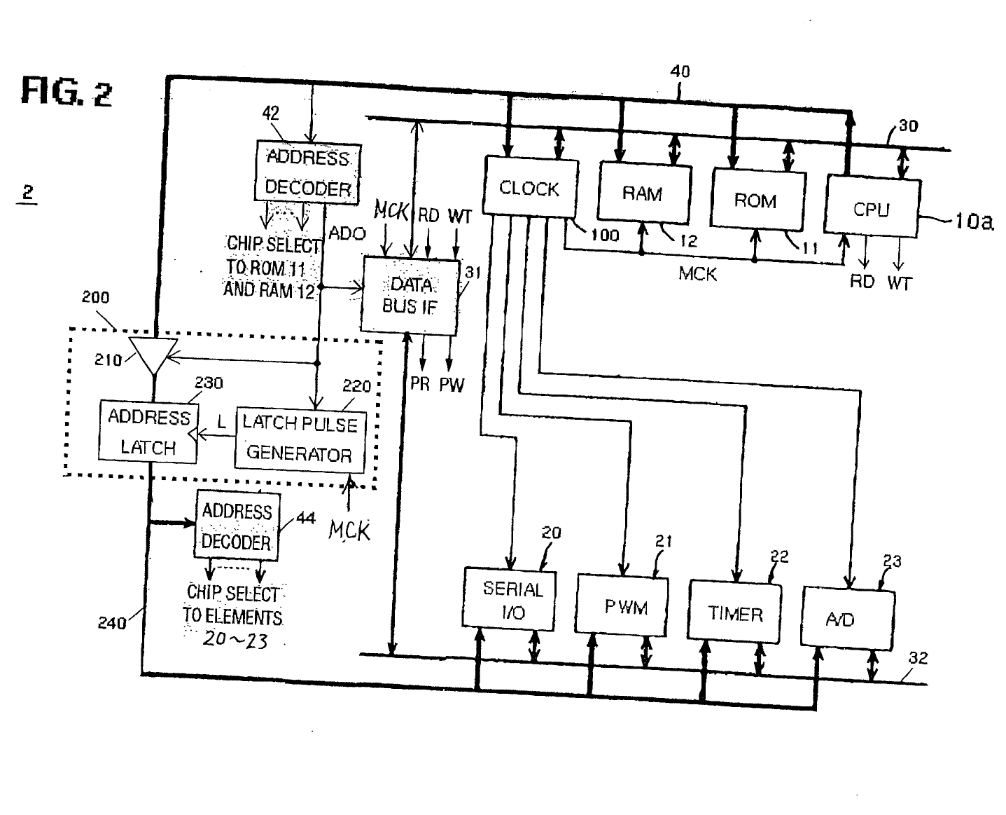

FIG. 2 is a functional block diagram showing an exemplary architecture of a single-chip microprocessor IC 2 the power consumption of which has been held down in accordance with an illustrative embodiment of the invention. In FIG. 2, the single-chip microprocessor IC 2 is identical to that of FIG. 1 except that:

(a) an address bus controller 200 has been inserted in a halfway point of the address bus 40 which point is in the downstream side of the peripheral address decoder 44, and

(b) the clock circuit 13 has been changed to the clock circuit 100 for supplying the peripheral devices 20 through 23 with respective frequency-optimized clock signals instead of the common machine clock MCK.

Inserting the address bus controller 200 causes the address bus 40 to be divided into core address bus 40 and peripheral address bus 240 commonly connected to the peripheral devices 20 through 23.

The address bus controller 200 comprises an address buffer 210 having its input connected with core address bus 40 and its enable terminal connected with the address decoder 42 output ADO; latch pulse generator 220 for generating a latch timing pulse L from the address decoder output ADO and the machine clock MCK; and address latch 230 that latches the output address from the address buffer 210 in response to the latch timing pulse L from the latch pulse generator 220. With this configuration, the address bus controller 200 latches the address value on the core address bus 40 when CPU 10a outputs an peripheral address on the address bus 40, i.e., when the address decoder 42 asserts the address decoder output ADO, and the address bus controller 200 continues to output the latched address value till controller 200 receives the next latch pulse.

In this way, the output of the address latch 230 changes only when address latch 230 receives a latch pulse from the latch pulse generator 220, i.e., only when CPU 10a has an access to any of the peripheral devices 20 through 23. This drastically reduces the switching operations of the address decoder 44 in the frequency, resulting in a decrease of the power consumption of the single-chip microprocessor IC 2.

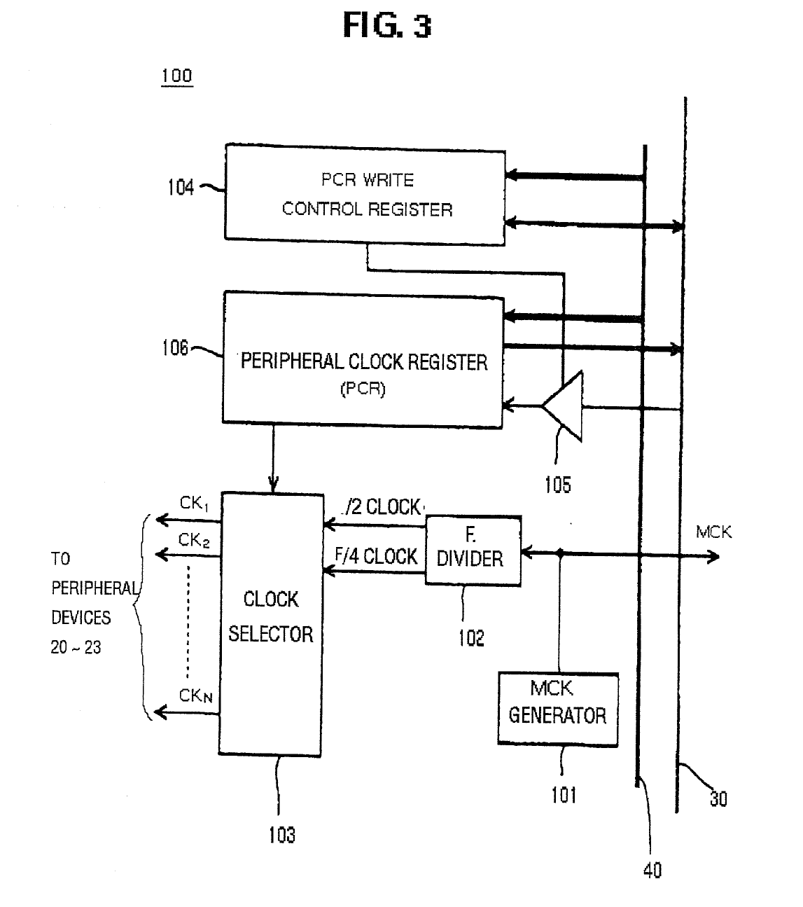

FIG. 3 is a block diagram showing an exemplary arrangement of the clock circuit 100 of FIG. 2. In FIG. 2, the clock circuit 100 comprises an MCK generator 101 for generating the machine clock MCK; a frequency (F) divider 102 for dividing the frequency of the machine clock MCK by factors of, e.g., 2 and 4 to provide clock signals of F/2 and F/4 in frequency (F is the frequency of the clock MCK); a clock selector 103 having its clock input terminals connected with the output terminals of the frequency divider 102 and its N clock output terminals CK1, CK2, . . . , CKN (N=4 in this specific example) connected with respective peripheral devices 20 through 23 for providing no clock signal or either of a half-frequency clock and a quarter-frequency clock for each of the clock output terminals according to a piece of clock control data set by CPU 10a; a peripheral clock resistor (PCR) 106 for storing a clock control data; a PCR write control resistor 104 for storing a PCR write control data that determines whether to permit CPU 10a to write and read data to and from the peripheral clock resistor (PCR) 106; and a data buffer 105 inserted between any bit of core data bus 30 and PCR 106 and having its enable input connected with the PCR write control resistor 104.

CPU 10a can write a piece of PCR write control data to register 104 at any time. However, CPU 10a is permitted to write or read data to or from peripheral clock resistor 106 only when predetermined data is stored in the resistor 104.

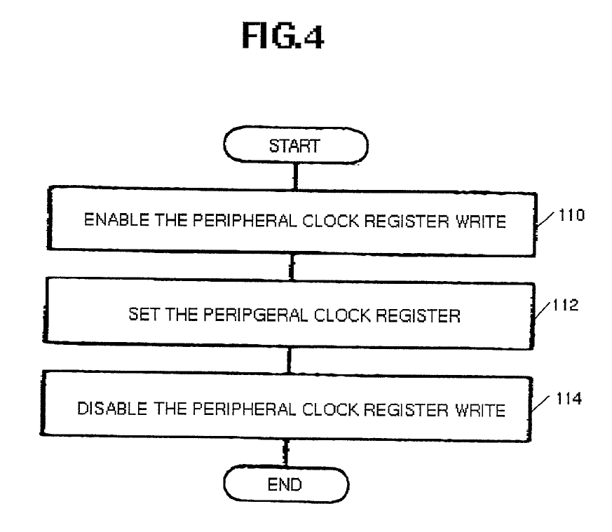

FIG. 4 is a flowchart showing an operation of the CPU 10a when CPU 10a sets the clock circuit 100 to control the way of the clock circuit 100 supplying clock signals to peripheral devices 10 through 23. It is assumed that the access to the peripheral clock resistor 106 is disabled by a power-on reset operation. For this reason, in order to program the clock circuit 10 or the peripheral clock resistor 106 into a desired state, CPU 10a first enable the PCR 106 write by writing a piece of predetermined data into the PCR write control resistor 104 in step 110. This causes the resistor 104 to assert its output signal to the data buffer 105, making the buffer 105 conductive, which in turn makes the PCR 106 accessible, i.e., enable the CPU 10a to write and read data to and from PCR 106.

In step 112, CPU 10a set a desired clock control value to PCR 106. In this case, the clock output terminals CK₁, CK₂, . . . , CK_{N} (i.e., the peripheral devices 20 through 23) are assigned respective pairs of bits of the set clock control value Dcc. For this, in order to store the entire clock control value Dcc, the peripheral clock register 106 preferably has a bit length of 2N bits. A pair of 2n-th and (2n+1)-th bits from the least significant bit in the value Dcc can take the flowing values indicating respective clock output states.

TABLE

a pair of bits

| 2n + 1 | 2n | clock output state |
|---|---|---|
| 0 | 0 | F/2 clock |
| 0 | 1 | F/4 clock |
| 1 | 0 | No clock |
| 1 | 1 | No clock |

In this table, n =0, 1, . . . , (N−1). A bit pair “00” indicates that an (n+1)-th clock output terminal CKₙ₊₁ outputs a half-frequency clock signal for example; a bit pair “01 ” indicates that a clock output terminal CKₙ₊₁ outputs a quarter-frequency clock signal for example; and bit pairs “10” and “11” indicate that a clock output terminal CKₙ₊₁ outputs no clock signal. It should be noted that the clock output states are not limited to the above listed states. There may be more clock output states than listed above, and more bits may be assigned to each peripheral device depending on the number of possible clock output states.

After setting the clock control value to PCR 106, CPU 10a disables the data-writing to PCR 106 by writing another predetermined value in the PCR write control register 104 in step 114.

Once a clock control value is set in PCR 106, the clock selector 103 halts the putting out of a clock signal or outputs either of the F/2 clock and F/4 clock through each of clock output terminals CK₁, CK₂, . . . , CK_{N}. By doing this, it is possible to provide each peripheral device with a frequency-optimized clock signal or to refrain temporarily from providing a clock for one or more specific peripheral device(s), causing each of peripheral devices 20 through 23 to halt or operate at an optimized speed. This also contributes to a reduction in the power consumption of single-chip microprocessor IC 2.

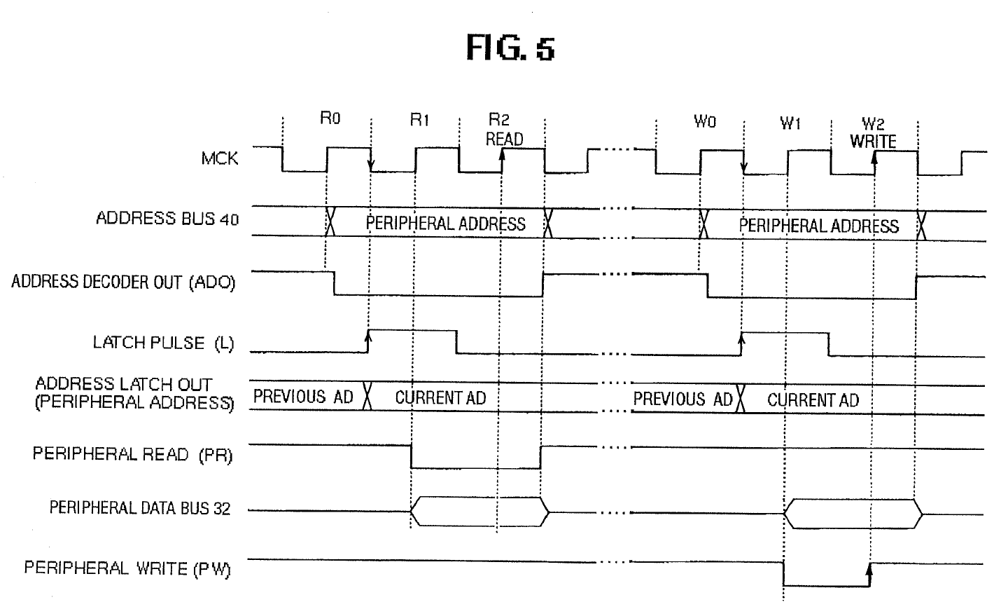

Peripheral read and write operations in thus configured single-chip microprocessor IC are described in the following. FIG. 5 is a timing chart showing the wave forms of relevant signals in a peripheral read operation and a peripheral write operation. A read or write operation takes 3 clock cycles R0 through R2 or W0 through W2. In FIG. 5, the address decoder output ADO, the peripheral read signal PR and the peripheral write signal PR are shown in the negative logic notation. It is assumed that in an initial state, the data buffer IF 31 is in a disable state, i.e., disables the data transfer between core data bus 30 and peripheral data bus 32.

In a peripheral read operation, CPU 10a first launches a desired peripheral address on the core address bus 40 at the rising edge of the first clock R0 of the read cycle, and then, though not shown in FIG. 5, activates the read line RD. The launched peripheral address is decoded by the address decoder 42, which in turn asserts an address decoder output signal ADO, which is supplied to data bus IF 31, address buffer 210 and latch pulse generator 220.

In response to the asserted signal ADO, the address buffer 210 becomes conductive to pass the peripheral address to address latch 230, and the latch pulse generator 220 generates a latch pulse L at the end of the first clock R0 of the read cycle. Address latch 230 is so configured as to latch the given peripheral address at the rising edge of the latch pulse and hold the latched peripheral address as the address latch output on the peripheral address bus 240 till address latch 230 receives another latch pulse.

In response to a change in the value of peripheral address bus 240, address decoder 44 activates one of the chip select signals associated with the launched peripheral address.

On the other hand, data bus buffer 31 starts a not-shown clock counter in response to an assertion of the address decoder output ADO, and makes the peripheral read signal PR active at the rising edge of the second clock R1 of the read cycle and, at the same time, enables the data transfer from peripheral data bus 32 to core data bus 30.

In response to the activation of the peripheral read signal PR, a peripheral device connected with the activated chip select line launches data on the peripheral data bus 32, which is transferred to core data bus 30 via data bus IF 31. Then, CPU 10a reads the data on core data bus 30 at the rising edge of the third clock R2 of the read cycle.

On the other hand, data bus buffer 31 deactivates the peripheral read signal PR at the end of the third clock R2 of the read cycle, which terminates the peripheral read cycle.

After reading the data on core data bus 30, CPU 10a ceases driving the address bus 40 and deactivates the read signal RD. This causes the address decoder 42 output ADO to become inactive, causing the data buffer IF 31 inactive.

In a peripheral write operation, a peripheral address is established on the peripheral address bus 240 in the same manner as in case of the above-described peripheral read operation. Thereafter, data bus IF 31 activates the peripheral write signal PW at the rising edge of the second clock W1 of the write cycle. Almost concurrently with the activation of PW, CPU 10a outputs the data to write on core data bus 30. The data is transferred to peripheral data bus 32 by data bus IF 31.

Then, data bus IF 31 deactivates the peripheral write signal PW at the rising edge of the third clock W2 of the write cycle. In response to the rising of the peripheral write signal PW, a peripheral device selected by address decoder 44 reads the data on the peripheral data bus 32. In other words, the peripheral devices 20 through 23 are preferably so configured as to start a reading operation in response to the rising edge of the peripheral write signal PW.

Subsequently, data bus IF 31 disables the data transfer between core data bus 30 and peripheral data bus 32 at the end of the third clock W2 of the write cycle, which terminates the driving of peripheral data bus 32. This completes the write cycle.

According to the invention, the output of the address latch 230 or the address bus controller 200 changes only when CPU 10a has an access to any of the peripheral devices. This drastically reduces the frequency of the switching operations by the address decoder 44, resulting in a decrease of the power consumption of the single-chip microprocessor IC 2.

Also, clock circuit 100 makes it possible to provide each peripheral device with a frequency-optimized clock signal or to refrain temporarily from providing a clock for one or more specific peripheral device(s), causing each of peripheral devices 20 through 23 to halt or operate at an optimized speed. This also contributes to a reduction in the power consumption of single-chip microprocessor IC 2.

Modification I

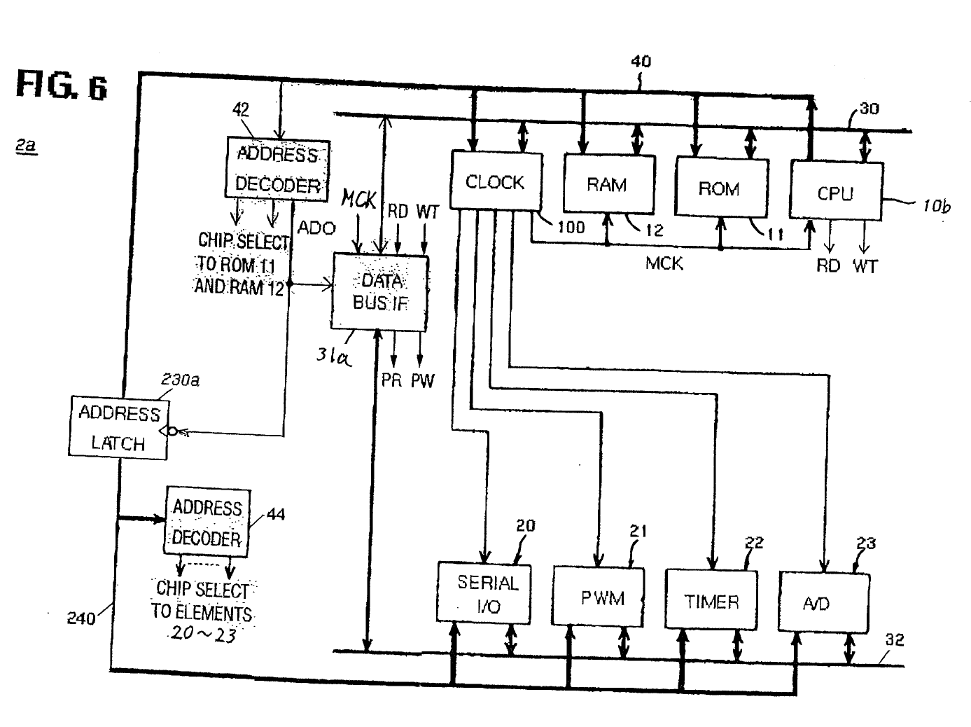

FIG. 6 is a functional block diagram showing an arrangement of a first modification of the single-chip microprocessor IC 2 of FIG. 2. In FIG. 6, the single-chip microprocessor IC 2a is identical to that of FIG. 2 except that CPU 10a, data bus IF 31 and address bus controller 200 have been replaced by CPU 10b, data bus IF 31a and an address latch 230a, respectively.

That is, in FIG. 6:

address buffer 210 and latch pulse generator 220 have been eliminated;

the address latch 230a has been inserted directly between core address bus 40 and peripheral address bus 240;

the address decoder 42 output ADO is connected to the clock input terminal of the address latch 230a;

CPU 10b is identical to CPU 10a except the timing of peripheral address launching as detailed later; and

data bus IF 31a is identical to data bus IF 31 except the output timing of the peripheral read PR and write PW signals.

It should be noted that the address latch 230a is of a type that latches the data at the falling edge of the signal applied to the clock input terminal.

Only the differences from the single-chip microprocessor IC 2 are described in the following operation description.

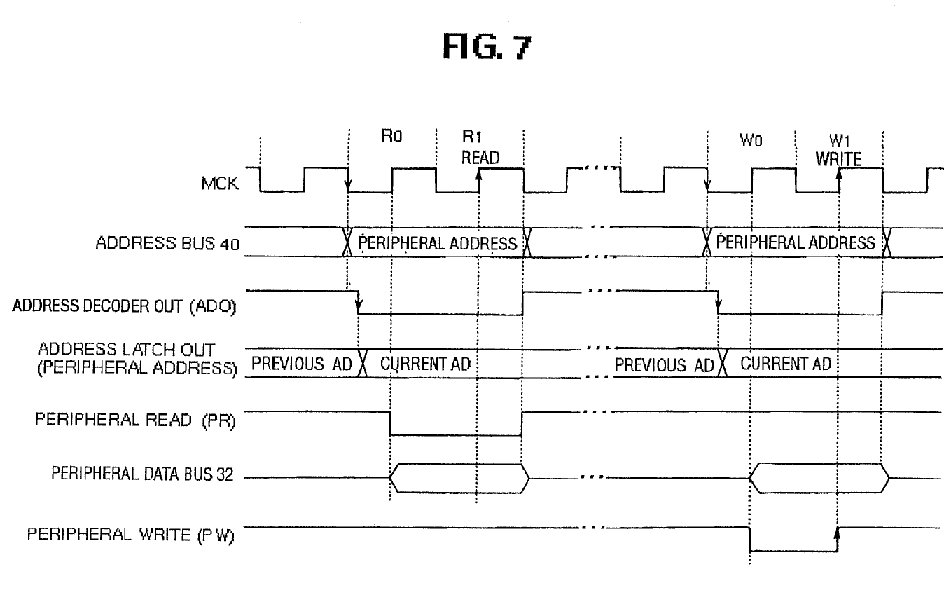

FIG. 7 is a timing chart showing the wave forms of relevant signals in a peripheral read operation and a peripheral write operation of the single-chip microprocessor IC 2a of FIG. 6.

In a peripheral read operation, CPU 10b first launches a peripheral address on core address bus 40 at the beginning of the first clock R0 of a peripheral read cycle. Decoding the peripheral address, address decoder 42 asserts the address decoder output signal ADO. The activation of the signal ADO causes the address latch 230a to latch the peripheral address at the falling edge of the signal ADO and keep providing the latched peripheral address on peripheral address bus 240 till the address latch 230a receives another falling change of the signal ADO. The activation of the signal ADO also causes data bus IF 31a to start the not-shown clock counter and activates the peripheral read signal PR and enables the data transfer from peripheral data bus 32 to core data bus 30 at the edge in the middle of the first clock R0 of the read cycle. This permits CPU 10b to read data from a peripheral device selected by address decoder 44 according to the peripheral address output by CPU 10b.

In a peripheral write operation, the address bus control is done in the same manner as in the read operation. Data bus IF 31a is so configured as to make the peripheral write signal PW active for a period of one clock from the edge in the middle of the first clock W0 in a peripheral write cycle. The peripheral devices 20 through 23 are so configured as to start a read operation at the end of the peripheral write signal PW.

According to a modified single-chip microprocessor IC 2a of FIG. 6, a further reduction in the power consumption is possible in addition to the reduction amount by the single-chip microprocessor IC 2 of FIG. 2 because the circuit is more simplified as compared with IC of FIG. 2.

Modification II

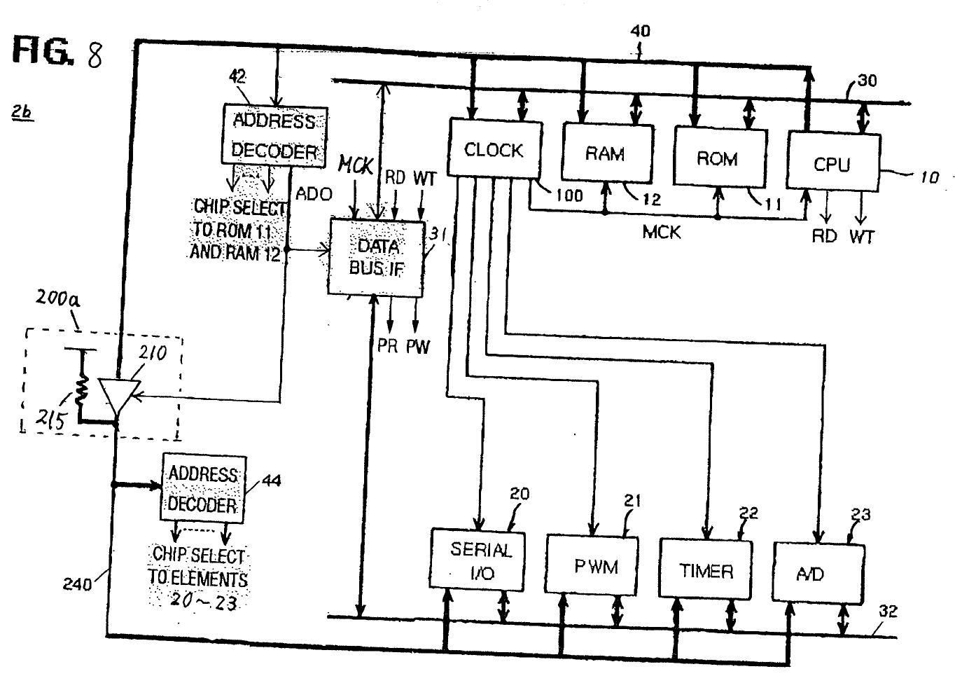

FIG. 8 is a functional block diagram showing an arrangement of a second modification of the single-chip microprocessor IC 2 of FIG. 2. In FIG. 8, the single-chip microprocessor IC 2b is identical to that of FIG. 2 except that the address bus controller 200 has been replaced with an address bus controller 200a. That is, in FIG. 8, the latch pulse generator 220 and the address latch 230 have been eliminated and the output of address buffer 210 has been directly connected to peripheral address bus 240 and all the bits of the address buffer 210 output have been pulled up to not-shown power supply via respective resistors 215.

According to this modification, the output of the address buffer 210 or the address bus controller 200a changes only at the beginning and at the end of each peripheral access cycle. This drastically reduces the frequency of the switching operations by the address decoder 44, resulting in a decrease of the power consumption of the single-chip microprocessor IC 2b.

Also, clock circuit 100 provides the same amount of reduction in the power consumption as IC 2 of FIG. 2 can provide.

makes it possible to provide each peripheral device with a

Modification III

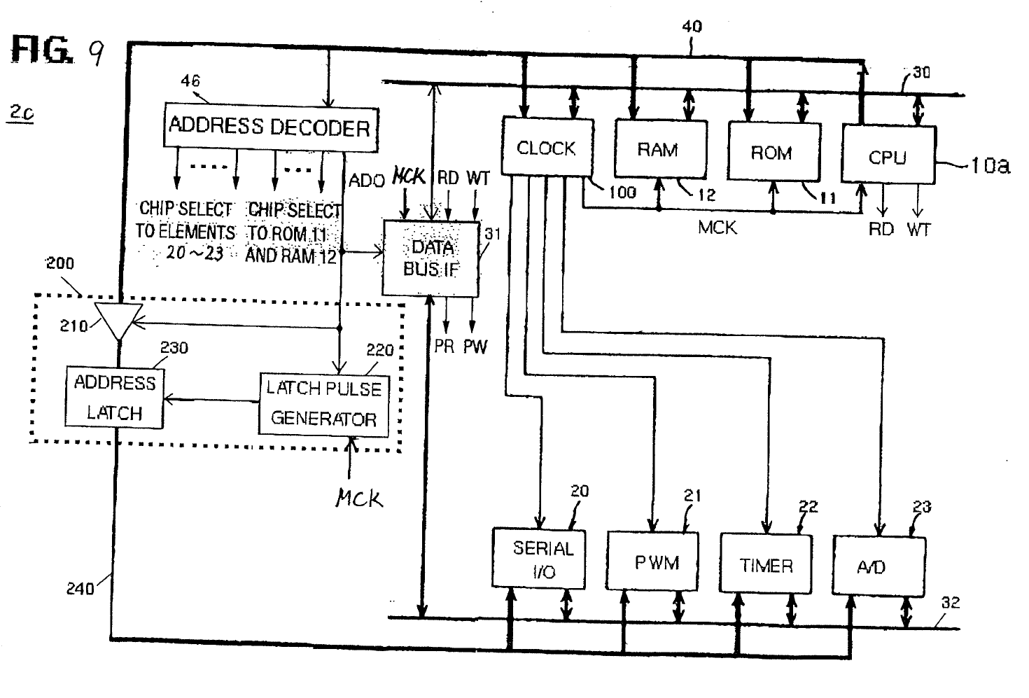

FIG. 9 is a functional block diagram showing an arrangement of a third modification of the single-chip microprocessor IC 2 of FIG. 2. In FIG. 9, the single-chip microprocessor IC 2c is identical to that of FIG. 2 except that the address decoder 44 has been incorporated with the address decoder 42 to become a new address decoder 46. The new address decoder 46 may be either a simple combination of address decoders 42 and 44 or a simplified combination of them. However, the portion of address decoder 46 that generates the chip select signals for peripheral devices 20 through 23 uses the data on the core address bus 40 which data includes memory addresses. For this reason, the reduction amount of power consumption of this modification is smaller than that of the IC 2 of FIG. 2.

The foregoing merely illustrates the principles of the invention. Thus, many widely different embodiments of the present invention may be constructed without departing from the spirit and scope of the present invention.

For example, the peripheral address bus 240 may correspond to the entirety or only a part of the core address bus 40. Especially, the peripheral address bus 240 may correspond to the address bits of the core address bus 40 other than used in the decoding by address decoder 42.

Though in the above described embodiments, single-chip microprocessors 2, 2a and 2b are provided with both of clock circuit 100 and address bus control means such as 200, 230a and 200a, a single-chip microprocessor may be provided with only one of them.

Each of the peripheral access cycles may be terminated by data bus IF 31 or 31a generating an acknowledge signal and CPU 10a or 10b detecting the acknowledge signal, respectively.

If the peripheral circuit 20-23 can be divided into a plurality of peripheral circuits or if a single-chip microprocessor IC includes a plurality of peripheral device groups, then an ADO signal generating decoder, a data bus IF 31, an address bus controller 200 and an address decoder 44 may be prepared for each of the peripheral circuits or the peripheral device groups.

It should be understood that the present invention is not limited to the specific embodiments described in the specification, except as defined in the appended claims.

What is claimed is:

1. A single-chip microprocessor integrated circuit (IC) including:
a CPU (central processing unit);
first address bus directly connected with said CPU;
a peripheral circuit; said peripheral circuit comprising:
a plurality of circuit blocks that are accessible from the CPU via data bus interface; and
a second address bus connected in common with said circuit blocks,
means for generating chip select signals for said circuit blocks; and
means, inserted between said first and second address buses, for passing at least a part of address data provided on said first address bus by said CPU to said second address bus only if said address data is a peripheral address intended for any of said circuit blocks, and
wherein said means for generating chip select signals operates on the basis of the data provided on said second address bus.

2. A single-chip microprocessor IC as defined in claim 1, wherein said means for passing at least a part of address data includes latch means for keep providing said at least a part of said address data on said second address bus till another peripheral address is received.

3. A single-chip microprocessor IC as defined in claim 1, wherein said means for passing at least a part of address data comprises:
buffer means the output terminals of which become of high impedance during periods other than said period of passing at least a part of address data; and
means for trying to keep said output terminals at a level of IC power supply.

4. A single-chip microprocessor integrated circuit (IC) including:
a CPU (central processing unit);
a peripheral circuit; said peripheral circuit comprising:
a plurality of circuit blocks that are accessible from the CPU,
means for generating a first clock signal used by said CPU;
means for providing each of said circuit blocks with one of predetermined clock signals.

5. A single-chip microprocessor IC as defined in claim 4, wherein said means for providing each of said circuit blocks includes means for providing at least one of said circuit blocks specified by said CPU with no clock.

6. A single-chip microprocessor IC as defined in claim 4, wherein said means for providing each of said circuit blocks operates according to a piece of control data given by said CPU.

7. A single-chip microprocessor IC as defined in claim 4, wherein said means for providing each of said circuit blocks includes means for generating said predetermined clock signals by dividing said first clock signal in frequency by predetermined division factor.
